(19) United States
(12) Patent Application Publication
(10) Pub. No.: US 2013/0177731 A1
(43) Pub. Date: Jul. 11, 2013

(54) THERMAL INSULATION STRUCTURE AND PRODUCTS MADE THEREFROM

(71) Applicant: ARC'TERYX EQUIPMENT INC., North Vancouver (CA)

(72) Inventor: Carl MORIARTY, North Vancouver (CA)

(73) Assignee: ARC'TERYX EQUIPMENT INC., North Vancouver (CA)

(21) Appl. No.: 13/734,183

(22) Filed: Jan. 4, 2013

Related U.S. Application Data
(60) Provisional application No. 61/583,905, filed on Jan. 6, 2012.

(51) Int. Cl. B32B 5/16; B32B 5/26; B32B 7/08

(52) U.S. Cl. CPC B32B 5/16; B32B 7/08; B32B 5/26
USPC 428/74; 5/413 R; 5/502; 2/69; 428/76

(57) ABSTRACT

A thermal insulating structure, and products made therefrom. The insulation structure includes an insulation-containing substructure that includes an inner and intermediate layers forming a plurality of successive compartments, the compartments containing insulation material, such as down or loose synthetic material. The intermediate layer is a batting of insulation, such as fiberfill or fleece. An outer layer, such as a waterproof material, extends over the substructure.

### CROSS-REFERENCE TO RELATED APPLICATION

This application is based upon U.S. Provisional Patent Application No. 61/583,905, filed Jan. 6, 2012, the disclosure of which is hereby incorporated by reference thereto in its entirety, and the priority of which is claimed under 35 U.S.C. §119(e).

### BACKGROUND

1. Field of the Invention

The invention relates to thermal insulation structures and materials, as well as products made therefrom, such products including, e.g., garments such as coats, jackets, and pants, as well as blankets, sleeping bags, and the like. Such products can particularly include lightweight products, waterproof products, as well as both lightweight and waterproof products.

More particularly, the invention relates to thermal insulation structures and materials, such structures comprising a plurality of layers, at least two of such layers having an interposed quantity of insulation material, such as down, such two layers with insulation forming a compartmentalized insulation substructure, such as a quilted substructure, the compartments being bounded by the two layers and, for example, successive lines of stitching. Even more particularly, at least one of such two layers itself can be a layer of insulative material, such as a batting of fiberfill or fleece.

2. Background Information

Whether for use in cold climates generally or for use during winter sports activities, for example, thermal insulation materials are necessary to maintain warmth. Accordingly, such materials are known to be used for the manufacture of blankets, sleeping bags, as well as for various categories of apparel, such as coats, jackets and pants useful during hiking, skiing, or other cold-weather activities.

Examples of conventional outer garments include those that employ insulation materials between inner and outer layers, such as an inner fabric layer and an outer shell. If such insulation materials are loose materials, in particular, whether synthetic or natural, i.e., synthetic materials such as filamentary nylon or polyester, or natural materials such as down, the inner and outer layers are known to be sewn together, forming a quilted structure. The lines of stitching of such quilted structures serve the purpose of preventing the loose insulation material from migrating within the cavity between the inner and outer layers. When used in garments, a quilted structure keeps the insulation material from moving downward and becoming largely amassed at the lower regions of the garments.

But an associated problem created by such quilted structures is the creation of cold areas along the lines of stitching, because the inner and outer layers are pinched together at the stitching lines, thereby eliminating any insulation material being interposed therebetween.

U.S. Pat. No. 5,713,079 discloses a “dual insulation garment” directed to this problem. The solution offered by U.S. '079 is to provide the garment with a double-layered quilted structure, whereby transverse lines of stitching—which create a series of horizontal insulation panels—are staggered, whereby the lines of stitching of the outer layer lie at midpoints between respective pairs of lines of stitching of the inner layer.

Although the U.S. '079 solution places a layer of insulation over respective lines of stitching, the result is a bulkier garment, a heavier garment, and one that is more complicated to manufacture—the required stitching being doubled and one that effectively includes not only inner and outer layer of insulation panels but the addition of two interior layers, i.e., an interior layer for each of such panels.

U.S. Pat. No. 1,421,906 discloses a similar structure for a “wadded quilt” or comforter, whereby an intermediate layer is added to top and bottom layers, which layers maintain double layers of insulation, such as layers of down.

### SUMMARY

The present invention provides an insulation structure, such as for a garment, blanket, or sleeping bag, e.g., which includes a substructure for containing a quantity of insulation material, such as down or loose synthetic material, the substructure including a plurality of successive compartments formed by first and second layers, one of which is an insulative layer itself, such as a batt, or batting, of fiberfill or fleece. Such an insulative layer according to the invention can provide a clothing insulation (clo) value of at least 0.40 (whereas 1 clo=0.155 m²K/W, m=meters, K=Kelvin, and W=watts), or at least about 0.40. The insulative batting eliminates or lessens the cold areas between the compartments, with an added benefit of a reduction in weight and complexity of the structure and associated product. An outer layer, or shell, such as a waterproof material, extends over the substructure. In a particular embodiment, the do value is at least 0.70 or at least about 0.70.

Whether the insulation structure takes the form of a garment or a blanket or a sleeping bag, e.g., the first layer of the insulation-containing substructure can be an inner layer that would engage a person, and the second layer can be an intermediate layer, positioned between the inner layer and the outer layer/shell.

The outer layer or shell is attached between spaced-apart regions, such as spaced-apart edges, of the insulation structure, with a plurality of the compartments of the substructure extending between such regions/edges. That is, the outer layer/shell is not stitched to the substructure, thereby allowing it to remain intact, and waterproof, by not being pierced by stitching, for example, between the aforementioned regions or edges.

As an alternative to stitching, the successive compartments can be bounded, i.e., bounded additionally to that provided by the first and second layers, by means of a succession of baffles extending between the first and second layers.

The batting of insulation that serves as a layer for containing the down or other insulation comprises fiberfill or fleece.

The first, or inner, layer can comprise a thin layer of nylon or taffeta.

### BRIEF DESCRIPTION OF DRAWINGS

Other features and advantages of the invention will be better understood from the following description, with reference to the annexed drawings illustrating, by way of non-limiting embodiments, how the invention can be implemented, and in which:

FIG. 1 is a schematic diagram showing an embodiment of a quilted structure according to the prior art;

FIG. 2 is a schematic diagram showing an embodiment of the invention;

FIG. 3 is a schematic diagram showing an alternative embodiment;

FIG. 4 is perspective view of portion of the embodiment of FIG. 2.

### DETAILED DESCRIPTION

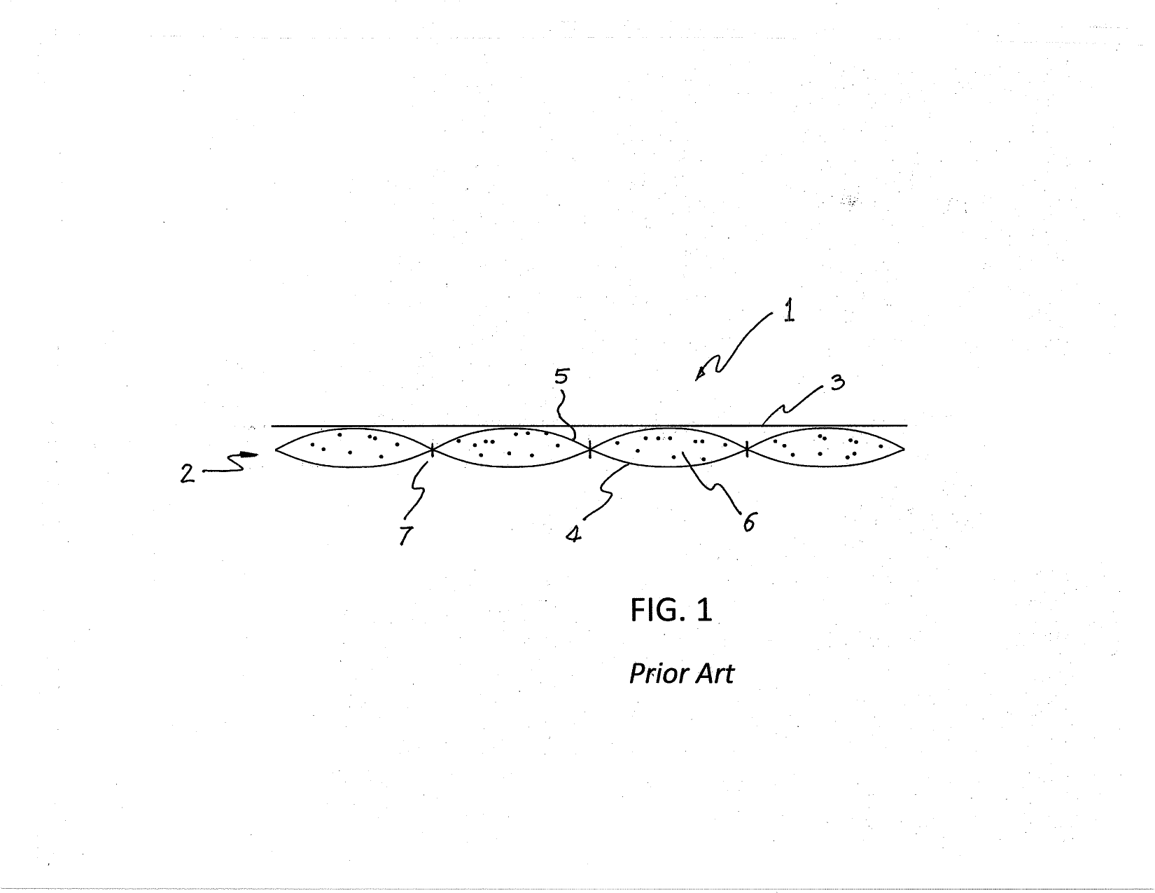

The following description, making reference to FIGS. 1-4, is relevant to the scope of the invention as described herein, but, for the purpose of explanation and understanding, the description makes reference to particular structures, details, and features which are not intended to limit the invention unless otherwise expressed. In this regard, for example, although reference is made to a product in the form of a jacket, such as a down jacket, products that incorporate the structures and materials described below include at least all those mentioned above, such as garments, blankets, sleeping bags, and others.

FIG. 1 is a cross-sectional view of a conventional quilted insulation structure 1 known in the prior art, useful for a thermal jacket, such as a down jacket. The insulation structure 1 includes an insulation substructure 2 overlaid with an outer layer 3, or shell. The substructure includes an inner layer 4 and an outer layer 5, the two layers containing an insulation material 6, such as down or a synthetic material, such as a loose material. With reference to the insulation structure 1, the layer 5 can be regarded as an intermediate layer, or mid-layer. For convenience in this description, the outer layer 5 of the substructure 2 will be referred to, below, as a mid-layer, it being understood that it is a mid-layer of the insulation structure 1. The inner layer 4 and mid-layer 5 typically are thin layers of nylon or polyester, such as a tightly woven fabric, such as taffeta. Such a layer, i.e., tightly woven polyester or nylon or blended material, has a weight such as about 70 g/m², and as great as 85 g/m², for example. Providing the purpose required, such layers should be as light as possible, inasmuch as heavier weights decrease the down “loft” or thickness, and the loft produces the insulation by encasing a larger volume of air between layers. Very light weights are suitable and could be as small as 30 g/m², although the cost of such materials increases as the weight decreases. It is known in the prior art to use a Gore-Tex® material for the outer layer, i.e., the shell 3.

At spaced-apart intervals, the insulation material 6 is contained within compartments, such as pockets or panels, between successive lines of stitching 7, thereby creating a quilted structure. In the case of a jacket, the quilted structure would effectively be characterized by compartments in the form of horizontal panels or tubes extending around the wearer's torso, as well as around the wearer's arms. Without the lines of stitching, the insulation material 6 can be susceptible to migrating within the containment provided by the two 4, 5. In the case of a jacket, the insulation material would become amassed at the lower extents of the torso and sleeves.

As can be seen in FIG. 1, along the lines of stitching 7, the inner layer 4 and mid-layer 5 are brought together. In fact, it can be seen that—from the midpoint between the seams—the thickness of the insulation material 6 tapers from a maximum to a minimum, such as zero, at the seams 7. Accordingly, the effectiveness of the insulation 6 in providing warmth for the wearer drops in the same manner, whereby, at the seams, only the thickness provided by the two layers 4, 5 is available for the wearer's warmth, particularly if an outer shell were not part of the structure 1. The outer shell serves to trap air between the shell layer 3 and the mid-layer 5, thereby providing some added level of insulation, although the amount of such trapped air is variable, even at the seams, inasmuch as no loft-providing insulation material is located in the space between the shell 3 and the substructure 2 and the shell 3 is prone to be compressed inward during use, particularly at the seams 7. Further, between the mid-layer 5 and the shell layer 3, significant convection currents are possible, thereby compromising the insulative effect of the shell 3 somewhat. In any event, for a person wearing a jacket having this quilted structure in a cold environment, rings of cold tend to surround his torso and arms.

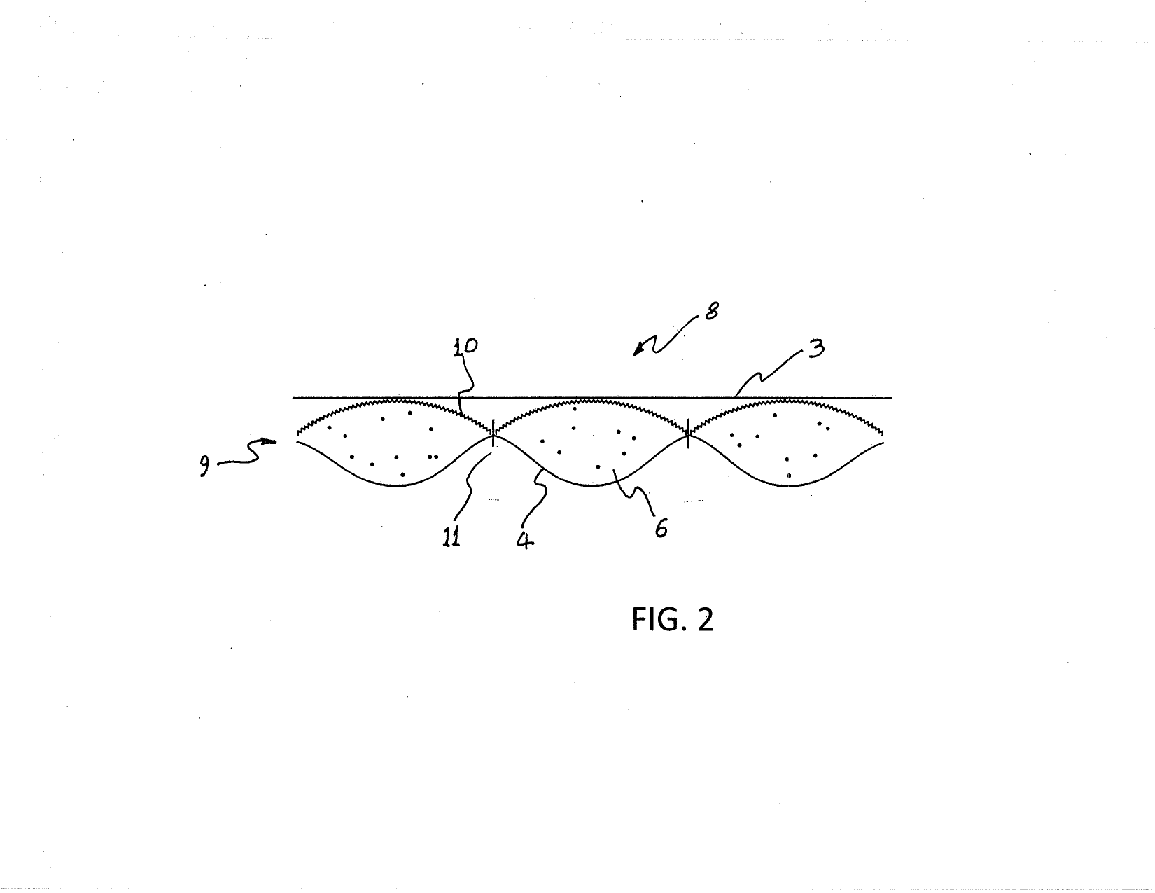

FIG. 2 schematically depicts a thermal insulation structure 8, in cross section through its thickness, according to an embodiment of the invention. Reference numerals used in FIG. 1 appear in FIG. 2 for those elements that can be used in the embodiment of FIG. 2. The insulation structure 8 of FIG. 2 includes a substructure 9 and an outer layer 3, or shell. The structure 8 is usable at least for all the products mentioned above.

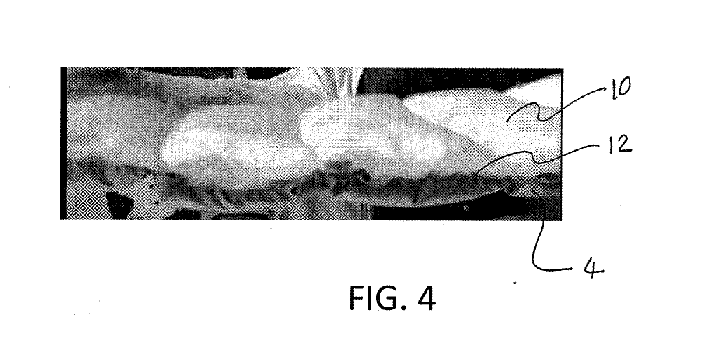

Included in the insulation structure 8 of FIG. 2 are an inner layer 4 and an intermediate or mid-layer 10. The outer layer 3, or shell, in a manner that could be used in the prior art of FIG. 1, is not stitched or otherwise directly connected to its substructure, except at peripheral edges thereof, e.g., such as at an edge 12, shown in FIG. 4.

According to a non-limiting optional construction detail of the invention, small dart seams are made on the inner layer 4 (which can be a woven textile material, e.g.), so that the down tends to gain its loft to the inside (i.e., the wearer's side) of the jacket—and the layer 10 remains relatively flat in comparison—so that it tends to sit more directly in contact with the outer layer 3 across its entire surface. That is, the difference in thickness between the stitch line 11 (i.e., the “valley”) and the maximum expanded thickness of the combination insulation (i.e., the “hill”) is less on the mid-layer side than on the inner-layer side.

Instead, the insulation material 6, such as down or other loose material, synthetic or natural, is contained within a substructure 9—here in the form of a quilted structure—formed by means of spaced-apart lines of stitching 11 or seams otherwise created, such as by means of gluing or welding, with a layer or quantity of insulation 10, such as fiberfill or fleece, either of which can include natural or synthetic fibers. In particular non-liming embodiments that utilize stitching to create the aforementioned quilted structure, the stitch counts are relatively “tight,” i.e., as great as ten stitches per inch or more, although the stitching line through the fiberfill or other insulative layer 10 can be six/inch or approximately six/inch. The layer or quantity of insulation 10 can be in the form of a batt or batting of insulation, such as a fiberfill batting, such as staple fibers batted by means of resins, or a fleece batting. As a non-limiting example, U.S. Pat. No. 4,869,771, the disclosure of which is incorporated-by-reference hereto in its entirety, describes a polyester fiberfill batt. The invention depicted in FIG. 2, in contrast with known prior art, includes a continuous layer of insulation between the down 6, or other insulation material, and the outer shell 3.

The batting of insulation used for the layer 10 in the construction of an insulated jacket, employing down, for example, can be a matted non-woven material having a thickness of at least 2 millimeters (mm), or at least about 2 mm, to about 6 mm or more, a do value of at least 0.40, or at least about 0.40, and a density of about 40 g/m² to about 80 g/m² or more. In a particular embodiment, the do value can be at least 0.70 or at least about 0.70.

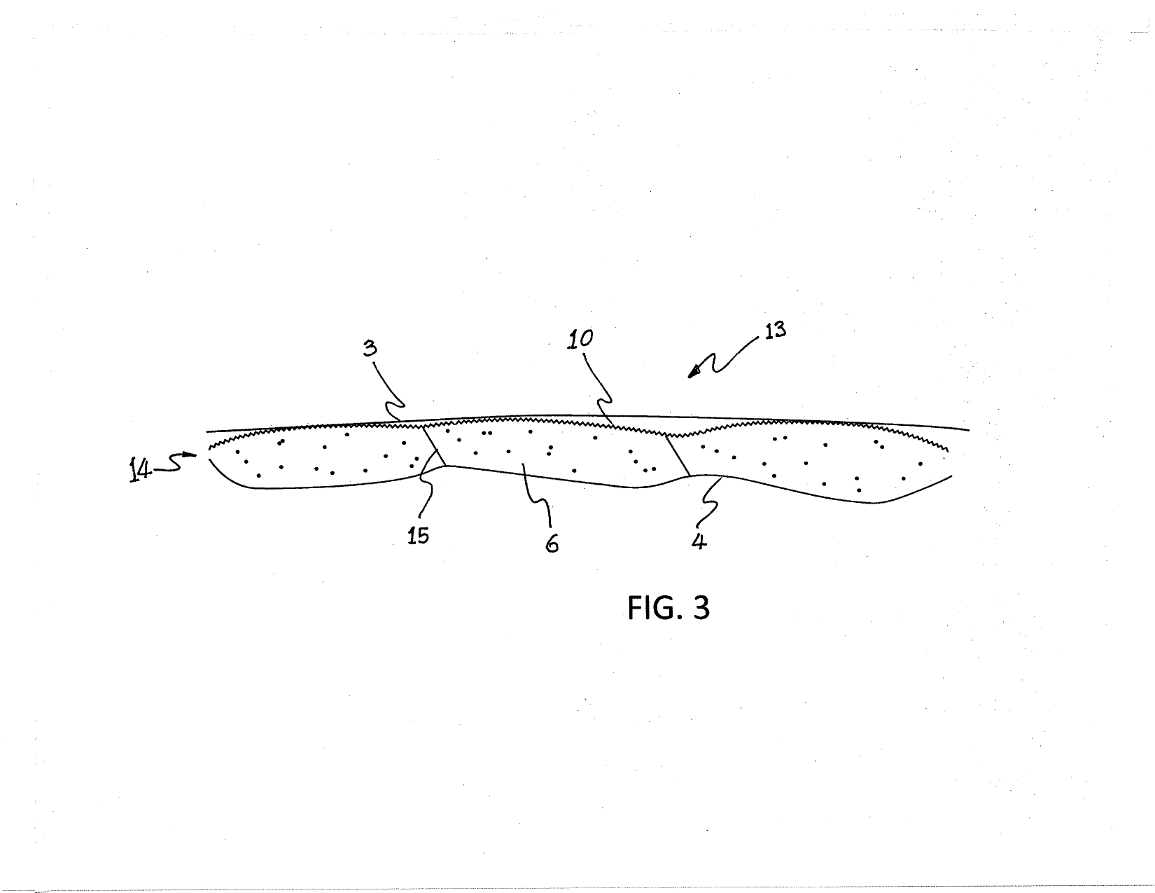

FIG. 3 schematically illustrates an alternative embodiment, comprising an insulation structure 13 comprising an insulation substructure 14 which provides an alternative to stitching together the two layers 4, 10 of FIG. 2. More particularly, rather than lines of stitching extending directly through the inner layer 4 and the mid-layer 10, or intermediate layer, a series of spaced-apart baffles 15 are sewn, or otherwise connected, to either one or both of the two layers. Such baffles can be made of fine mesh, such as a tricot knit, a mesh, to which the down plumules tend to stick by virtue of getting caught in the interstices of the knit. This tends to keep the down from “falling away” from the baffles (as might happen if they were of a tightly woven downproof material like the inner layer), thus reducing the potential for a “cold spot” near the baffle. This construction allows the two layers 4, 10 to be more greatly separated. Thereby, rather than the thickness of the down 6 or other insulation material tapering to zero or close to zero, a greater thickness of insulation is positioned near the edges of each of the insulation compartments of the quilted structure. However, in such an embodiment, if the baffles are stitched to the layer 10, a waterproofing tape could be used over the lines of stitching to facilitate the resulting product maintaining its waterproof integrity. Alternatively, the baffles could be welded or glued to the inner surface of the layer 10, whereby the outer surface of the layer 10 would not be pierced.

The FIG. 3 baffled structure, per se, with inner layer and mid-layer of nylon or taffeta sandwiching a layer of down or other insulation material, i.e., without a insulative or fiberfill intermediate or mid-layer of the invention, and, e.g., without an outer shell, is known for constructing down jackets and sleeping bags. See, for example, U.S. Pat. No. 1,893,548.

Whether the edges of the insulation-containing compartments between successive seams or baffles are structured as described with reference to FIGS. 2 and 3, the intermediate layer 10 is a layer of insulation material, such as fiberfill or fleece. As a non-limiting example, such fiberfill layer can be made from the TMK fiberfill product of Thermore®, particularly with the so-called “compact” thickness (i.e., chosen from among the four available options of high loft (HL), compact (C), super compact (SC), and ultra compact (UC)). This fiberfill product is in the form of a batt, or batting, having a thickness of approximately 3 to approximately 6 millimeters (or approximately 0.125 to approximately 0.25 inches), and is available as a roll of 100 yards in length and 60 inches in width. Although such fiberfill can be obtained in any of various densities, such as between 40 g/m² and 200 g/m², favorable results are obtained with fiberfill in the range of 40 g/m² and 80 g/m². In this range, the fiberfill layer 10 has a weight comparable to that of nylon taffeta, which can be used for the inner layer 4, i.e., the layer closest to the wearer of a jacket made with the illustrated structure. The insulative value of the fiberfill layer within this range has a rating of at least 0.40 do, or at least about 0.40 do, based on the test method ASTM D 1518. In a particular embodiment, as mentioned above, the do value can be at least 0.70 or at least about 0.70. The aforementioned TMK fiberfill product, 40 g Compact, has a clo value of approximately 0.79 and the 80 g Compact product has a do value of 1.49. The aforementioned ratings, or values, provide for good thermal qualities and yet maintain a light weight for the product thus made, such as a jacket. Further, this fiberfill product allows a variance in the thickness of a chosen weight/density without a proportional loss in thermal value. For example, the thickness of the 170 g/m² density product can be reduced by half with only a 10% reduction in warmth. Although fiberfill is described as being a suitable insulative material for the layer 10, any of other insulative materials can be used provided that it has certain insulative characteristics, such as a do value of at least 0.70. Such materials can include wool, felt, e.g., or other materials, for example. By contrast, a 70 g/m² taffeta intermediate layer 3 of the prior art (see FIG. 1) might have a do value of no greater than about 0.2.

The inner layer 4 of the insulation structures 8 and 13 can be a basic woven nylon or polyester, for example, or even cotton. A tightly woven material can be advantageous for retaining down as the insulation material 6. In short, the material used for the inner layer can be almost anything that is tightly enough woven to prevent the escape of the down, or to prevent significant down escape (i.e., such material thereby being “downproof”). The inner layer 4 can have a density of approximately 28 g/m² to 70 g/m²; approximately 40 g/m² provides good results without being too heavy.

The outer layer 3 of the insulation structures 8 and 13 can be a layer of Gore-Tex®, which provides a waterproof and breathable outer shell. Ideally, other than at the peripheral regions or edges of the insulation structure, the Gore-Tex® layer is not sewn through at any point, such as to create tubes or compartments for the down or other insulation material.

Although Gore-Tex® is mentioned, the invention is not limited to the use of Gore-Tex® as the outer shell layer. Suitable advantageous embodiments can include an outer layer that is not Gore-Tex®, such as one that is at least windproof and water repellent (i.e., even if not waterproof), provided that it is breathable. If Gore-Tex® is used, one of the lighter versions of the material can be used, such as the ProShell® backer and a relatively light face fabric, i.e., a three-layer Gore-Tex® with the lightest laminate on the inner side.

Advantages of the thermal insulation structures according to the invention, particularly those that employ an intermediate layer 10 made of fiberfill, e.g., include (1) a lightweight and relatively inexpensive structure, and (2) a structure that provides greater insulation by having the intermediate or mid-layer made of fiberfill rather than a basic light woven taffeta that might otherwise be used, such as in the prior art of FIG. 1. A third advantage is that, for locations in a product, such as a jacket, where it is cool enough for moisture in the air to begin to condense (i.e., the dew point) are more likely to be outside the insulation layer/down 6 and the fiberfill layer 10 (the latter being immediately adjacent the outer shell, i.e., the Gore-Tex® layer) helps to keep the insulation layer/down dry. A fourth advantage is that, by virtue of the thickness and insulative property provided by the layer 10, the seams 7, e.g., are kept farther away from moving ambient air, i.e., any convection currents.

In short, the insulation structures of the invention keep the outer shell layer completely intact and waterproof (i.e., not sewn through or seamed), while saving weight and minimizing heat loss, particularly with the outer shell not being sewn through. Further, although an insulation structure of the invention can be manifested by means of the baffled structure shown in FIG. 3, having a fiberfill or other insulative intermediate layer 10, completed with an outer layer 3 of Gore-Tex® or other material, the insulation structure shown in FIG. 2 provides a less expensive and lighter weight structure than the baffled structure of FIG. 3. The fiberfill insulation batting, or other non-woven, or matted, insulative batting, at about the same weight as the thinner woven mid-layer that it replaces according to the invention, provides a product—whether a down jacket or other product—that remains light and flexible while providing additional insulation to product, while lessening the disadvantage of any cold areas created by seams.

In an alternative embodiment, an additional layer of material, such as a light tricot mesh or a mosquito mesh, can be positioned between the fiberfill layer 10 (or other batting of insulation) and the down 6 (or other insulation material) if, for example, it were desired to add to the strength provided by the layer 10 in containing the insulation 6, or if it were desired to provide a screen to prevent the insulation 6 from contacting the layer 10. In particular structural variations of such an embodiment, the mesh layer (or other such additional layer) could be tacked to the fiberfill layer 10, i.e., sewn around the perimeter thereof, or the mesh layer could be bonded to the fiberfill layer, in sheet or continuous form.

The invention is not limited to the particular embodiments described above, but includes all equivalents that fall within the scope of the claims that follow. For example, a quilted structure according to the invention can include intersecting lines of stitching, thereby creating polygonal compartments, such as square, rectangular, diamond-shaped, or other compartments, such as curvilinear.

In addition, the invention can be made and using manufacturing methods and techniques known to those of ordinary skill in the art.

At least because the invention is disclosed herein in a manner that enables one to make and use it, by virtue of the disclosure of particular exemplary embodiments of the invention, the invention can be practiced in the absence of any additional element or additional structure that is not specifically disclosed herein.

1. An insulation structure comprising:
a quantity of insulation material;
an insulation-containing substructure comprising:
a first layer;
a second layer comprising a batting of insulation;
a plurality of successive compartments bounded by the first and second layers;
the quantity of insulation material being contained within the plurality of compartments.
an outer layer extending over the insulation-containing substructure, the second layer being positioned between the outer layer and the first layer.

2. An insulation structure according to claim 1, wherein:
the insulation structure is a product constructed and arranged to be laid against or worn by a person;
the first layer of the insulation-containing substructure comprises an inner layer for engagement with the person.

3. An insulation structure according to claim 1, wherein:
the outer layer is attached between spaced-apart regions of the insulation structure, a plurality of the compartments of the substructure extending between said regions of the outer layer with the outer layer not being attached to the insulation-containing substructure between said regions.

4. An insulation structure according to claim 3, wherein:
the spaced-apart regions of the insulation structure comprises opposite edges of the insulation structure.

5. An insulation structure according to claim 1, wherein:
the batting of insulation comprises a non-woven material.

6. An insulation structure according to claim 5, wherein:
the batting of insulation has a thickness of at least 3 mm.

7. An insulation structure according to claim 1, wherein:
the batting of insulation comprises fiberfill or fleece.

8. An insulation structure according to claim 7, wherein:
the quantity of insulation material comprises down.

9. An insulation structure according to claim 1, wherein:
the quantity of insulation material comprises down.

10. An insulation structure according to claim 1, wherein:
the batting of insulation comprises a fiberfill material.

11. An insulation structure according to claim 10, wherein:
the fiberfill material has a clo value of at least 0.40, based upon test method ASTM D1518.

12. An insulation structure according to claim 10, wherein:
the fiberfill material has a weight in a range of approximately 40 g/m² to approximately 80 g/m²

13. An insulation structure according to claim 1, further comprising:
successive spaced-apart lines of stitching connecting the first and second layers;
the successive lines of stitching defining respective boundaries of the successive compartments.

14. An insulation structure according to claim 1, further comprising:
successive spaced-apart baffles extending between the first and second layers;
the successive baffles defining respective boundaries of the successive compartments.

15. An insulation structure according to claim 1, wherein:
the outer layer is a waterproof material.

16. An insulation structure according to claim 1, wherein:
the outer layer is a waterproof and breathable material.

17. An insulation structure according to claim 1, wherein:
the inner layer made of a tightly woven or knit material.

18. An insulation structure according to claim 17, wherein:
the tightly woven or knit material is a material selected from nylon, polyester, cotton, and polypropylene.

19. An insulation structure according to claim 1, further comprising:
an additional layer positioned between the batting of insulation and the quantity of insulation material.

20. An insulation structure according to claim 19, wherein:
the additional layer comprises a mesh layer.

21. A garment comprising the insulation structure according to claim 1.

22. A blanket or sleeping bag comprising the insulation structure according to claim 1.
